(19) United States
(12) Patent Application Publication
(10) Pub. No.: US 2024/0109380 A1
(43) Pub. Date: Apr. 4, 2024

(54) BUSH STRUCTURE

(71) Applicant: HONDA MOTOR CO., LTD., Tokyo (JP)

(72) Inventors: Ryosuke KUNO, Wako-shi (JP); Isao OBATA, Wako-shi (JP); Hisashi ISHIMATSU, Wako-shi (JP)

(21) Appl. No.: 18/475,367

(22) Filed: Sep. 27, 2023

(30) Foreign Application Priority Data
Sep. 29, 2022 (JP) 2022-157089

(51) Int. Cl. B60G 7/00

(52) U.S. Cl. CPC B60G 7/001; B60G 2204/41

(57) ABSTRACT

A bush includes an outer cylinder fitting to an inner side of a bush mounting part, an inner cylinder arranged inside the outer cylinder, a rubber bush disposed between the outer cylinder and the inner cylinder, and a pair of ring members arranged between the outer cylinder and the inner cylinder and contacting with the outer cylinder and the rubber bush. The inner cylinder includes a bulging part at a portion of a circumferential surface thereof. An outermost diameter of the bulging part is larger than those of other portions in the inner cylinder. The outermost diameter is formed larger than the innermost diameter of each ring member.

### CROSS-REFERENCE TO RELATED APPLICATIONS

This application is based upon and claims the benefit of priority from Japanese Patent Application No. 2022-157089 filed on Sep. 29, 2022; the entire contents of which are incorporated herein by reference.

### BACKGROUND OF DISCLOSURE

### 1. Technical Field

The present disclosure relates to a bush structure.

### 2. Description of Related Art

Conventionally, a bush structure includes a flange-shaped fixing part positioned at both upper and lower ends of a rubber layer located between an outer cylinder and an inner cylinder (e.g., refer to Japanese Unexamined Patent Application Publication No. H8-210409). In such a bush structure, a ring-shaped recessed portion is arranged at a middle position between upper and lower ends of a rubber layer. Further, connecting and fixing the outer cylinder with the rubber layer via a resin layer covering a circumference of the outer cylinder increases a spring rate or spring constant of the bush structure in an axial direction thereof.

### SUMMARY OF DISCLOSURE

However, a conventional bush structure uses a plurality of different materials, leading to necessity of the larger number of processes and an increase in manufacturing cost. Further, covering a circumference of the outer cylinder with a resin layer raises a disadvantage that the covering resin increases a diameter of the entire bush, leading to increases in size and weight thereof. In view of the above, there is still room to further improve the conventional bush structure.

The present disclosure is directed to a bush structure which achieves not only reduction of manufacturing cost but improvement of a spring constant of the bush in an axial direction thereof.

For solving the above disadvantage, a bush structure of the present disclosure includes an outer cylinder, an inner cylinder arranged inside the outer cylinder, a rubber bush arranged between the outer cylinder and the inner cylinder, and at least one ring member which is arranged between the outer cylinder and the inner cylinder and contacts with the outer cylinder and the rubber bush.

The present disclosure provides a bush structure which not only reduces manufacturing cost but improves a spring constant of the bush in an axial direction thereof.

### BRIEF DESCRIPTION OF DRAWINGS

FIG. 1 is a perspective view of a bush structure in Embodiment 1 of the present disclosure showing a configuration near a suspension arm at a lower part of a vehicle.

FIG. 2 is a longitudinal cross-sectional view of the bush structure in Embodiment 1 along the II-II line in FIG. 1 showing a configuration inside the bush.

FIG. 3 is a partially cross-sectional view of the bush structure in Embodiment 1 showing a configuration inside the bush.

FIG. 4 is a longitudinal cross-sectional view of a bush structure in Embodiment 2 of the present disclosure showing a configuration inside the bush.

### DESCRIPTION OF EMBODIMENTS

Hereinafter, an embodiment of the present disclosure will be described in detail via appropriately referring to the attached drawings. It should be noted that in principle, same component members are denoted by the same reference sign, and redundant explanations are omitted. Furthermore, when a direction is described, the direction is determined based on directions of longitudinal, lateral and vertical with respect to a driver in a vehicle. Note, a term of “vehicle width direction” is identical to that of “lateral direction”.

### Embodiment 1

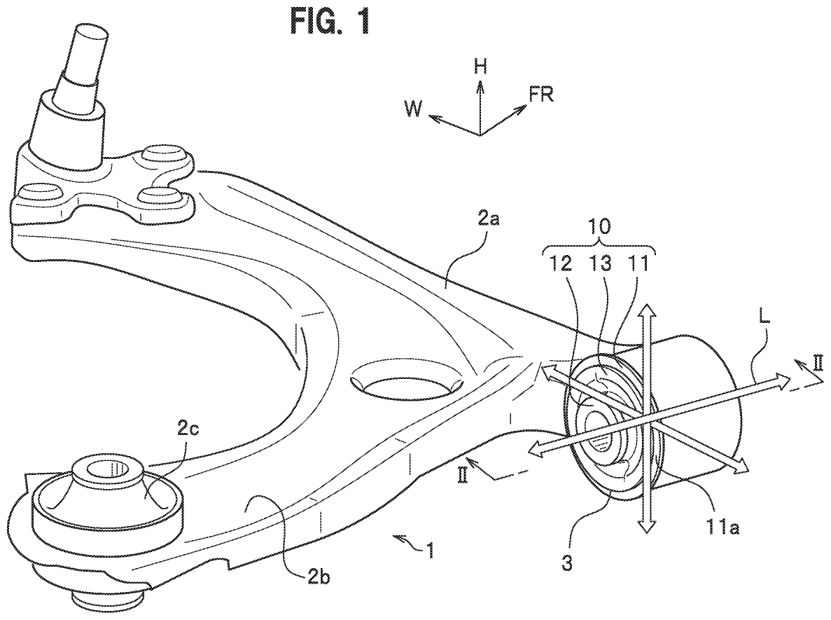

FIG. 1 shows a bush 10 to which a bush structure of Embodiment 1 of the present disclosure is applied. At a lower part of a vehicle, a pair of left and right suspension arms 1, 1 are arranged. Hereinafter, a suspension arm 1 at a left side of the vehicle is described, and a configuration and effects at a right side of the vehicle formed in a bilaterally symmetrical shape are omitted.

The suspension arm 1 is configured in an approximately “r” shape in a plan view and integrally includes an arm body 2a arranged along a vehicle width direction W, and a rear arm 2b extending from an inside to a rear side of the arm body 2a.

A bush mounting part 3 for mounting the bush 10 is arranged at an end of the arm body 2a located near a center of the vehicle body. Further, an outer end of the arm body 2 is connected to a hub carrier (not shown) which supports a wheel.

Among those parts, the bush mounting part 3 includes a cylindrical through-hole formed in an axial direction L of the bush mounting part 3 along a longitudinal direction FR of the vehicle.

The bush 10 is inserted in the through-hole of the bush mounting part 3 along the axial direction L. Thereby, the suspension arm 1 is supported via the bush 10 thus attached to an attachment part (not shown) of the vehicle body.

Further, a rear end of the rear arm 2b is connected to the vehicle body through a compliance bush 2c having a center axis thereof in a vertical direction. Hereby, the suspension arm 1 is installed at a lower part of the vehicle.

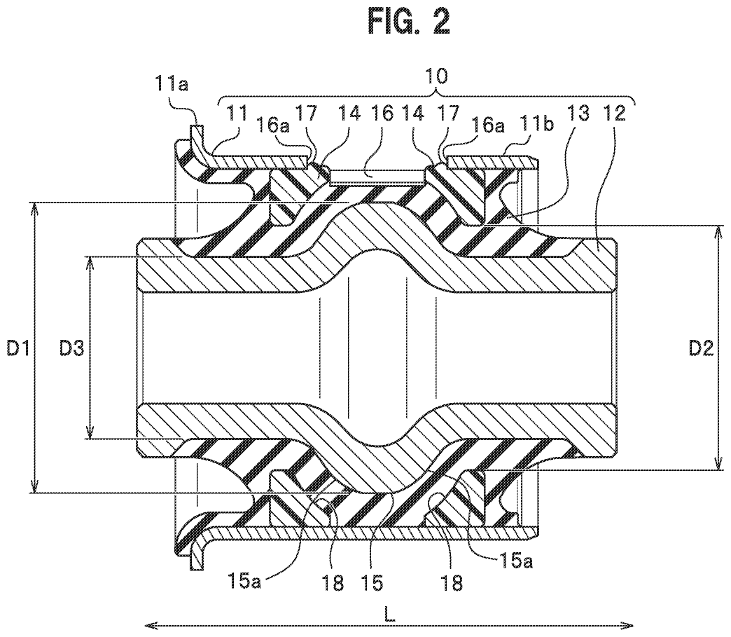

As shown in FIGS. 1 and 2, the bush 10 includes an outer cylinder 11 which is inserted inside and fitted in the bush mounting part 3; and an inner cylinder 12 which is arranged inside the outer cylinder 11 and attached to the attachment part of the vehicle body. Further, the bush 10 includes a rubber bush 13 arranged between the outer cylinder 11 and the inner cylinder 12. Furthermore, the bush 10 includes a pair of ring members 14, 14 arranged between the outer cylinder 11 and the inner cylinder 12, the pair of ring members 14, 14 contacting with the outer cylinder 11 and the rubber bush 13.

Here, the outer cylinder 11 made of metal has a cylindrical shape. Therein, an annular exterior flange 11a is formed as radially enlarging from an opening arranged at an end of the outer cylinder 11 in the axial direction L to an outside of the outer cylinder 11. The outer cylinder 11 is inserted inside the through-hole of the bush mounting part 3 from an opposite end located at an opposite side of the end where the opening is arranged. In a state that the outer cylinder 11 fits to an inside of the through-hole, the external flange 11a is engaged with a peripheral edge of the opening of the through-hole and thus positioned in the axial direction L, so that the outer cylinder 11 is fixed on the bush mounting part 3.

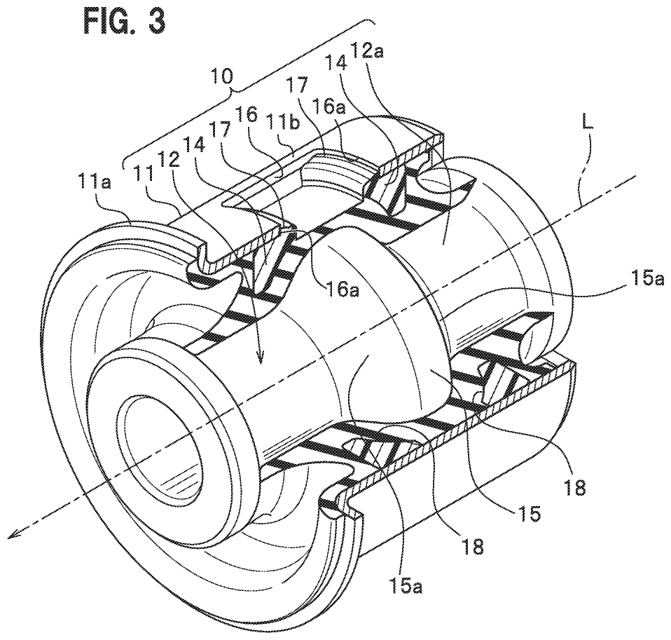

As shown in FIG. 3, the outer cylinder 11 in Embodiment 1 includes a hole part 16 which perpendicularly opens to the axial direction L at a portion of a circumference surface 11b. The hole part 16 is positioned between both ends of the outer cylinder 11 in the axial direction L. The hole part 16 is formed to pass through the outer cylinder 11 at a portion of the circumference surface 11b in a circumferential direction so that the hole part 16 is formed from inside to outside in an approximately rectangular shape in a side view.

Further, the inner cylinder 12 made of metal is formed in a cylindrical shape thicker than the outer cylinder 11 (see FIG. 2). The inner cylinder 12 in Embodiment 1 has a bulging part 15 at a portion of a circumference surface 12a, an outermost diameter thereof being larger than that of other portions.

The bulging part 15 is formed all over a circumference of the inner cylinder 12 positioned between both ends thereof in the axial direction L. A size D1 of an outermost diameter of the bulging part 15 is set larger than a size D3 of an outermost diameter of other portions of the circumference surface 12a (i.e., D1>D3). Thereby, the bulging part 15 is formed so that a longitudinal cross-section thereof has an approximately chevron shape bulging outward in a radial direction of the inner cylinder 12.

Further, an outermost diameter D1 of the bulging part 15 is formed so that D1 is larger than an innermost diameter D2 of each ring member 14 (i.e., D1>D2).

The rubber bush 13 is formed of an elastically deformable rubber elastomer. As shown in FIG. 2, the rubber bush 13 has a constricted shape in which both ends thereof in the axial direction L are recessed to form recessed shapes in a longitudinal cross-section.

The rubber bush 13 is arranged between the outer cylinder 11 and the inner cylinder 12 to support a load applied between the outer cylinder 11 and the inner cylinder 12 in the axial direction L by elasticity of the rubber bush 13 in a shearing direction. Further, the load applied between the outer cylinder 11 and the inner cylinder 12, in a vertical direction which orthogonally intersects the axial direction L (i.e., vertical direction H in FIG. 1) or in a lateral direction which orthogonally intersects the axial direction L (i.e., vehicle width direction W), is supported by the rubber bush 13 via compressed/expanded by elasticity thereof in the radial direction.

As mentioned above, arrangement of the hole part 16 at an upper side of the outer cylinder 11 allows a spring constant in the vertical direction H to be decreased more than spring constants in the axial direction L and the lateral direction orthogonally intersecting the axis direction L (i.e., vehicle width direction W).

The ring member 14 is formed of a resin in an annular shape, having a circular opening to pass therethrough in the axial direction L. The pair of ring members 14, 14 are embedded in the rubber bush 13 and disposed at a predetermined interval in the axial direction L. Further, the hole part 16 of the outer cylinder 11 is arranged between the pair of ring members 14, 14. Furthermore, an inner periphery of each ring member 14 is arranged along an inner periphery 16a of the hole part 16.

Further, each ring member 14 is fixed along on an inner wall of the outer cylinder 11 by a counterforce generated by interference when the ring member 14 is installed inside the outer cylinder 11 and adhesion using an adhesive agent.

Further, the ring members 14, 14 respectively include a hook part 17 arranged protruding toward an outside in a radial direction at a portion of a circumferential surface. The hook parts 17, 17 respectively are urged to contact and lock with a pair of inner peripheries 16a, 16a disposed opposite to each other at a predetermined interval, the hook parts being engaged outward with respect to the axial direction L. This structure allows a load applied in the axial direction L by both ends of the bush 10 to be supported by the respective ring members 14, 14, resulting in an increase in the spring constant.

The ring member 14 as shown in FIG. 2 includes a slope part 18 of which inner diameter D2 becomes larger as closer to the bulging part 15 in the axial direction L. Further, the ring member 14 is formed so that the longitudinal cross-sectional shape is an approximately right-angled isosceles triangle. Furthermore, the slope part 18 positioned at a hypotenuse of the above triangle shape is formed to have an angle of about 45 degrees to the axial direction L.

Further, the respective slope parts 18, 18 of the ring members 14, 14 are arranged at both sides of the bulging part 15 in the axial direction L via installing the rubber bush 13. Thereby, the slope parts 18, 18 are respectively arranged confronted with corresponding inclined wall parts 15a, 15a of the bulging part 15. The inclined wall parts 15a, 15a have an angle of about 45 degrees to the axial direction L.

### Embodiment 2

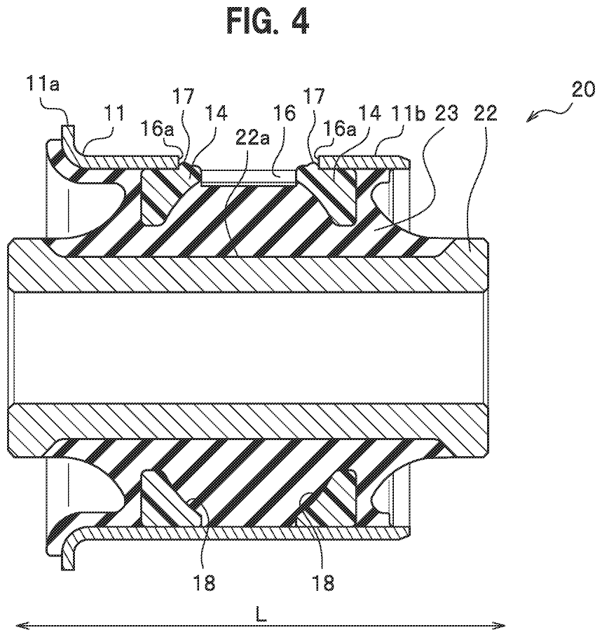

FIG. 4 illustrates a bush 20 in Embodiment 2 of the present disclosure. Note, the same or equal parts as/to those of the bush 10 in Embodiment 1 are denoted by a same reference sign, and redundant descriptions are omitted.

The bush 20 in Embodiment 2 is formed in a straight columnar shape such that a circumferential surface 22a of an inner cylinder 22 has a same outer diameter through over an approximately whole area of the circumferential surface 22a. A part corresponding to the bulging part 15 in Embodiment 1 (see FIG. 2) is not formed in Embodiment 2.

An inner wall of a rubber bush 23 in Embodiment 2 pressingly contacts with a circumferential surface 22a of the inner cylinder 22 having a straight columnar shape. This configuration of the inner wall supports a load applied between the outer cylinder 11 and the inner cylinder 22 in the axial direction L by elasticity of the rubber bush 23 in a sharing direction.

Further, a ring member 14 in Embodiment 2 has a slope part 18 such that an inner diameter thereof becomes larger as closer to a middle side thereof in the axial direction L of the rubber bush 23.

The bush 20 in Embodiment 2 configured as mentioned above doesn't need effects of the bush 10 in Embodiment 1 and further formation of the bulging part 15 on the inner cylinder 12 in Embodiment 1 at the inner cylinder 22 by carrying out drawing processing and so on. This feature allows the number of processes to be decreased, resulting in more reduction of manufacturing costs.

Here, other configurations and effects are the same as of the bush 10 in Embodiment 1. Therefore, redundant descriptions are omitted.

As mentioned hereinbefore, the bush structure of the present embodiments has a following feature. The bush 10 includes the outer cylinder 11, the inner cylinder 12 arranged inside the outer cylinder 11, and the rubber bush 13 disposed between the outer cylinder 11 and the inner cylinder 12. Further, the bush 10 includes one or more ring members 14, 14 each of which is arranged between the outer cylinder 11 and the inner cylinder 12 and contacts with the outer cylinder 11 and the rubber bush 13.

The bush structure in the embodiments as configured above prevents a respective whole size of the bush 10 and the bush 20 from increasing in the radial direction, leading to reduction of manufacturing costs. Further, this bush structure allows the spring constant in the axial direction L to be improved.

More specifically, as shown in FIG. 2, the ring member 14 is arranged between the outer cylinder 11 and the inner cylinder 12 and contact with the outer cylinder 11 and the rubber bush 13. Hereby, a load applied to the inner cylinder 12 of the bush 10 in the axial direction L is supported by the ring member 14 via compressing the rubber bush 13 and transmitted to the outer cylinder 11.

Accordingly, the bush 10 enables a spring constant in the axial direction L to be improved without increasing a size and weight thereof.

Further, a pair of ring members 14, 14 in the embodiments are arranged separately in the axial direction L. This configuration allows a load compressing the rubber bush 13 to be supported respectively by the pair of ring members 14, 14 independently at two positions in the axial direction L. Therefore, the bush 10 enables a spring constant in the axial direction L to be more improved.

Further, it is unnecessary to form a constricted shape, etc., by carrying out a drawing process of the outer cylinder 11. Hereby, this advantage enables reduction of the number of manufacturing steps, resulting in reduction of manufacturing costs of the bush 10.

Further, as FIG. 2 shows, at the inner cylinder 12 the bulging part 15 is formed on the circumferential surface protruding toward outside in a radial direction. A size D1 of an outermost diameter of the bulging part 15 is larger than a size D3 of an outermost diameter of other parts. Further, an outermost diameter D1 of the bulging part 15 is formed so that D1 is larger than an innermost diameter D2 of the respective ring members 14, 14 (i.e., D1>d2).

Thereby, the bulging part 15 and the ring members 14, 14 are partially overlapped in the axial direction L. Accordingly, the bush 10 in Embodiment 1 enables a spring constant in the axial direction L to be more improved.

Further, in Embodiment 1 slope parts 18, 18 of the pair of ring members 14, 14 are respectively confronted in the axial direction L with a pair of inclined wall parts 15a, 15a respectively formed at both inclined portions of the bulging part 15.

Therefore, the rubber bush 13 is installed between the pair of slope parts 18, 18 and the corresponding pair of inclined wall parts 15a, 15a as having the same thickness and the same angle in the radial direction.

Thereby, even when a bulging amount of the bulging part 15 and an inclined angle of the inclined wall part 15a (for example, within 45 degree) are set in an optional range without deteriorating durability of the inner cylinder 22, the setting enables the spring constant to be improved and draw processing or the like to be easily performed.

Further, the outer cylinder 11 includes a hole part 16 perpendicularly opening to an outside of the outer cylinder 11 to the axial direction L. Each ring member 14 includes a hook part 17 at an outer side thereof in the radial direction. The hole part 16 contacts with the respective hook parts 17, 17 in the axial direction L.

Thereby, the respective ring members 14, 14 support loads applied thereto in two directions by both ends of the bush 10 in the axial direction L.

Therefore, this structural feature enables a spring constant in the axial direction L to be further improved.

Further, positioning the hole part 16 formed in the outer cylinder 11 in a circumferential direction thereof enables different spring constants to be respectively set for the hole part 16 and other parts in a direction perpendicular to the axial direction L (i.e., a vertical direction H or a vehicle width direction W shown in FIG. 2). This setting allows a property of the bush 10 to be easily adjusted with adapting to a purpose of use.

The ring members 14, 14 in Embodiment 1 shown in FIG. 2 respectively include a slope part 18 in which an inner diameter D2 of a portion thereof becomes larger as the portion is closer to the bulging part 15 in the axial direction L.

This structural feature enables a desirable spring constant to be achieved by the ring members 14, 14 fixed on the outer cylinder 11, even when the number of processing the outer cylinder 11 is reduced.

Further, in Embodiment 1, as shown in FIG. 2, the bulging part 15 has an outermost diameter D1 at a middle of the circumferential surface 12a of the inner cylinder 12 in the axial direction L. The outermost diameter D1 is formed so that D1 is larger than the innermost diameter D2 of the respective ring members 14, 14 (i.e., D1>D2).

This structural feature enables the respective ring members 14, 14 to be partially overlapped with the bulging part 15 in the axial direction L, leading to more improvement of the spring constant.

Further, the respective ring members 14, 14 are formed so that each longitudinal cross-sectional shape thereof is configured in a rectangular equilateral triangle thereby to make each slope part 18 be confronted with the corresponding inclined wall part 15a formed on the bulging part 15. Thus, the rubber bush 13 disposed between the ring members 14, 14 and the inclined wall parts 15a, 15a of the bulging part 15 can stabilize the spring constant.

Furthermore, this structural feature makes no risk for deteriorating durability of the outer cylinder 11 when compared to a possible case which demands drawing processing to form a constricted portion with a small diameter size on the outer cylinder 11. Additionally, the structural feature exerts practically advantageous effects, for example, of preventing an increase in manufacturing costs required for the drawing processing.

The present disclosure is not limited to the above-described embodiments. The present disclosure can be carried out in various modes. The above-described embodiments represent the carried-out examples of the present disclosure so that the present disclosure can be easily understood. For this reason, the technical scope of the present disclosure shall not be limitedly construed due to the above-described embodiments including all the structures in the descriptions hereinbefore. Further, a part of configurations in an embodiment can be replaced with a configuration in other embodiments. Furthermore, configurations in other embodiments can be added to a configuration in an embodiment. In addition, a part of configurations in each embodiment can be deleted, or configurations of other embodiments can be added thereto and/or replaced therewith. For example, possible variations of the above-described embodiments are the followings.

In the embodiments, the pair of ring members 14, 14 are arranged between the outer cylinder 11 and the inner cylinder 12 and contact with the outer cylinder 11 and the rubber bush 13. However, the configuration is not specially limited to this one and a single or multiple like three or more ring members 14 can be arranged. Namely, as long as the ring member 14 is configured to be arranged between the outer cylinder 11 and the inner cylinder 12 to contact with the outer cylinder 11 and the rubber bush 13, such a ring member 14 may be applicable in use. A shape, the number and a material of the ring member 14 are not limited to examples in the embodiments.

Further, in Embodiments 1 and 2, the hole part 16 is formed in a portion of the outer cylinders 11, 21. However, a configuration thereof is not specially limited to this mode. The hole part 16 may not be arranged or multiple like two or more may be formed. Namely, a shape, the number and a position of the hole part are not specially limited.

1. A bush structure comprising:
an outer cylinder,
an inner cylinder arranged inside the outer cylinder,
a rubber bush arranged between the outer cylinder and the inner cylinder,
at least one ring member arranged between the outer cylinder and the inner cylinder and contacting with the outer cylinder and the rubber bush.

2. The brush structure according to claim 1, wherein
the inner cylinder includes a bulging part at a portion of a circumferential surface thereof, the bulging part having an outermost diameter larger than other parts of the inner cylinder, and
the outermost diameter of the bulging part is larger than an innermost diameter of the ring member.

3. The brush structure according to claim 1, wherein
the outer cylinder includes a hole part perpendicularly opening to an axial direction of the outer cylinder,
the ring member includes a hook part at an outer side thereof in a radial direction thereof, and
the hole part and the hook part contact with each other in the axial direction.

4. The brush structure according to claim 2, wherein
the outer cylinder includes a hole part perpendicularly opening to an axial direction of the outer cylinder,
the ring member includes a hook part at an outer side thereof in a radial direction thereof, and
the hole part and the hook part contact with each other in the axial direction.

5. The brush structure according to claim 2, wherein
the ring member includes a slope part of which inner diameter becomes larger as closer to the bulging part in an axial direction of the inner cylinder.

6. The brush structure according to claim 3, wherein
the inner cylinder includes a bulging part at a portion of a circumferential surface thereof, an outermost diameter of the bulging part being larger than those of other portions of the circumferential surface,
the ring member includes a slope part of which inner diameter becomes larger as closer to the bulging part in the axial direction.

7. The brush structure according to claim 4, wherein
the inner cylinder includes the bulging part at the portion of the circumferential surface, an outermost diameter of the bulging part being larger than those of other portions of the circumferential surface,
the ring member includes a slope part of which inner diameter becomes larger as closer to the bulging part in the axial direction.
